(19) United States
(12) Patent Application Publication
(10) Pub. No.: US 2024/0311282 A1
(43) Pub. Date: Sep. 19, 2024

(54) METHOD FOR AUTOMATED ANALYSIS OF SOFTWARE TESTS

(71) Applicant: Robert Bosch GmbH, Stuttgart (DE)

(72) Inventor: Safouane Sfar, Pfullingen (DE)

(21) Appl. No.: 18/442,933

(22) Filed: Feb. 15, 2024

(30) Foreign Application Priority Data
Mar. 13, 2023 (DE) 10 2023 202 222.2

(51) Int. Cl. G06F 11/36

(52) U.S. Cl. CPC G06F 11/3688

(57) ABSTRACT

A method for the automated analysis of software tests of a software. The method includes: ascertaining an error log about an incorrect execution of the software, wherein the error log specifies an execution context of the incorrect execution; ascertaining test logs that result from a performance of the software tests of the software that preceded the incorrect execution of the software, wherein the software tests include a plurality of existing test cases, through which various functions of the software are tested, wherein the test logs specify a respective execution context of the existing test cases; carrying out an evaluation of the test logs based on the error log, wherein the evaluation takes place based on a similarity of the execution context of the incorrect execution to the respective execution context of the existing test cases, wherein the evaluation takes place at least partially based on machine learning.

### CROSS REFERENCE

The present application claims the benefit under 35 U.S.C. § 119 of German Patent Application No. DE 10 2023 202 222.2 filed on Mar. 13, 2023, which is expressly incorporated herein by reference in its entirety.

### BACKGROUND INFORMATION

The present invention relates to a method for the automated analysis of software tests. The present invention furthermore relates to a computer program, a device, and a storage medium for this purpose.

### BACKGROUND INFORMATION

Conventionally, automated performance of test cases can be provided within the scope of software tests. Test cases may be checks that check the response of a software system to unexpected or incorrect inputs. These tests in particular aim at identifying potential error sources in the software that lead to crashes or unexpected behavior.

The automation of software tests has proven to be useful in order to achieve improved test coverage and thus improved software production. It is conventional to use methods for automating test patterns. Various testing methods and techniques are able to find errors or defects in the implemented software during the entire software test lifecycle. Methods for test leakage analysis can help to find problems that pass from one test phase to the next, and can thereby determine the effectiveness of the tests.

However, it is possible that particular defects or errors are present at the innermost levels of the software. As a result, it may be possible that conventional testing methods are unable to detect and identify all errors and defects.

### SUMMARY

The present invention provides a method, a computer program, a device, and a computer-readable storage medium. Example embodiments, features, and details of the present invention arise from the disclosure herein. Features and details which are described in connection with the method according to the present invention of course also apply in connection with the computer program according to the present invention, the device according to the present invention, and the computer-readable storage medium according to the present invention, and respectively vice versa, so that, with respect to the disclosure, mutual reference is or can be made to the individual aspects of the present invention at all times.

The present invention provides a method for the automated analysis of software tests of a software. According to an example embodiment of the present invention, the method comprises the following method steps, which are preferably performed in an automated and/or repeated and/or computer-supported manner:
ascertaining an error log about an incorrect execution of the software, wherein the error log preferably specifies an execution context of the incorrect execution, preferably in that the error log indicates at least one called function and/or input values and/or an execution environment and/or an output of the software at the time and/or as a precondition and/or as a result of the incorrect execution;
ascertaining test logs that result from a performance of the software tests of the software, which in particular preceded the incorrect execution of the software, wherein the software tests can comprise a plurality of existing test cases, through which various functions of the software can be tested, wherein the test logs specify a respective execution context of the existing test cases, preferably in that they specify at least one called function and/or input values and/or an execution environment and/or an output of the software at the time and/or as a precondition and/or as a result of the execution of the test cases;
carrying out an evaluation of the test logs on the basis of the error log, wherein the evaluation preferably takes place on the basis of a similarity of the execution context of the incorrect execution to the respective execution context of the existing test cases.

This in particular allows for a test leakage analysis to be carried out in an automated manner. Furthermore, it may be provided that the evaluation takes place at least partially on the basis of machine learning. It can thus be feature of the present invention to use the capabilities of machine learning (ML) in an automated manner in order to support a test leakage analysis. This achieves the advantage that the effort involved in identifying test leakages can be reduced. Furthermore, the method can help the tests to become more comprehensive and mature. The use of AI (artificial intelligence) can make it possible to produce more sophisticated software and to create more intelligent automated tests by said AI learning from detected errors or bugs.

Test cases are an important component within the scope of software tests and are used to ensure that the software functions flawlessly and reliably. A test case for software tests can be defined by a specific instruction and/or by a set of steps. The instruction and/or the steps can describe what is to be tested, in particular functions of a software, and/or how it is to be tested, and/or what results are expected. In this respect, a test objective for the test case can be specified and the test conditions can be defined. Furthermore, it can be defined for the test case, in particular step by step, what is to be tested, including the actions that need to be taken to achieve the test objective. The expected results for the test case can then be defined. However, in practice, errors often occur in such test cases where a function experiences a code change affecting parameters used to identify the function. Examples of such changes include changing the label parameter, changing the type of an object, or changing the parent container. If a function has changed, an identification of the element can fail, and the test may also perform unintended actions, which can lead to a cascade of errors. The adaptation and maintenance with regard to such changes traditionally required considerable effort to investigate, update, and repeat successive tests in order to verify the corrected test case.

It may also be possible that the method according to and example embodiment of the present invention generates, on the basis of the evaluation carried out, a test case that is suitable for reproducing the incorrect execution. In other words, a new test case that is suitable for reproducing the incorrect execution in contrast to the existing test cases can be generated. The generation of the test case can, for example, take place by means of a machine learning model trained for this purpose. This has the advantage that the consideration of the similarity of the execution context by machine learning can be trained in an automated manner to on this basis generate a test case that was still missing in the software tests for a comprehensive check of the software.

The execution context can in particular comprise information that specifies the context with regard to the inputs and/or outputs of the software and, if necessary, further execution conditions in the execution of the software according to the test case or in the incorrect execution. For this purpose, the execution context can, for example, be specified by a log of inputs and/or outputs of the software.

In a further possibility of the present invention, it can be provided that the generated test case is based on at least one of the existing test cases, wherein the following steps are preferably carried out for the generation:
identifying the at least one of the existing test cases whose execution context has the greatest similarity to the execution context of the incorrect execution, preferably by means of a machine learning model trained for this purpose, such as a neural network;
adapting the identified at least one test case so that it is suitable for reproducing the incorrect execution.

The adaptation can take place by changing a parameterization of the test case. Within the scope of a test case, a check of the software can, for example, be carried out in that the software is executed according to the parameterization of the test case.

For this purpose, the parameterization can, for example, specify which functions are executed with which parameter values. In this case, it may, for example, also be specified which elements of a user interface of the software are activated. The response of the software can then be evaluated, error states can be detected, and the software can thus be checked for unexpected or incorrect inputs.

According to a further possibility of the present invention, it can be provided that the following steps are carried out:
executing the generated test case;
checking that or whether the incorrect execution of the software is reproduced by the execution of the generated test case;
adapting the software such that an error underlying the incorrect execution of the software is corrected in a program code of the software; and/or integrating the generated test case into a testing process.

Furthermore, according to an example embodiment of the present invention, it can be provided that a generative machine learning model, preferably a neural network, is provided in order to carry out the evaluation within the scope of the method according to the present invention, and preferably in order to generate, on the basis of the ascertained error and test logs, a test case that is suitable for reproducing the incorrect execution. The machine learning model can have at least one of the following network architectures: a variational autoencoder, a generative adversarial network, an autoregressive model. This, for example, allows for the use of machine learning (ML) in order to deduce which steps were previously carried out with the associated configurations in connection with a serious defect or error. It can also allow for potential improvements in a test suite for the software tests to be proposed. The proposed solution is thus in particular based on the analysis of logs provided in the event of a serious error in comparison to logs stored by previous test campaigns, using machine learning algorithms.

Within the scope of an example embodiment of the present invention, it can be provided that the machine learning model is trained or has been trained by the following steps:
ascertaining training data, wherein the training data can comprise example error logs about various incorrect executions of the software and example test logs about software tests of the software, wherein test cases of the software tests preferably lack suitability for reproducing the incorrect executions, and wherein the training data comprise annotation data specifying test cases that are suitable for reproducing the incorrect executions;
initiating weightings of the machine learning model;
carrying out a training process in order to optimize the weightings of the machine learning model on the basis of the training data, wherein the training process uses a loss function that minimizes a difference between the data generated by the machine learning model and the annotation data.

It is also optionally possible that, when the evaluation is carried out repeatedly in the method according to the present invention, continuous learning of the machine learning model is provided, preferably on the basis of the thereby ascertained error and test logs, preferably through re-training, in which the ascertained error and test logs are included in the training data, and/or through incremental learning.

The present invention also relates to a computer program, in particular a computer program product, comprising instructions that, when the computer program is executed by a computer, cause said computer to perform the method according to the present invention. The computer program according to the present invention thus has the same advantages as described in detail with reference to a method according to the present invention.

The present invention also relates to a data processing device configured to perform the method according to the present invention. The device can, for example, be a computer that executes the computer program according to the present invention. The computer can comprise at least one processor for executing the computer program. A non-volatile data memory in which the computer program can be stored and from which the computer program can be read by the processor for execution can be provided as well.

The subject matter of the present invention can also be a computer-readable storage medium which comprises the computer program according to the present invention and/or instructions that, when executed by a computer, cause said computer to carry out the method according to the present invention. The storage medium is, for example, designed as a data store, such as a hard drive and/or a non-volatile memory and/or a memory card. The storage medium can, for example, be integrated into the computer.

In addition, the method according to the present invention can also be designed as a computer-implemented method.

Further advantages, features, and details of the present invention arise from the following description, in which exemplary embodiments of the present invention are described in detail with reference to the figures. In this context, the features mentioned herein can each be essential to the present invention individually or in any combination.

### BRIEF DESCRIPTION OF THE DRAWINGS

FIG. 1 shows a schematic visualization of a method, a device, a storage medium, and a computer program according to exemplary embodiments of the present invention.

FIG. 2 shows a further schematic representation of details of the method according to exemplary embodiments of the present invention.

### DETAILED DESCRIPTION OF EXAMPLE EMBODIMENTS

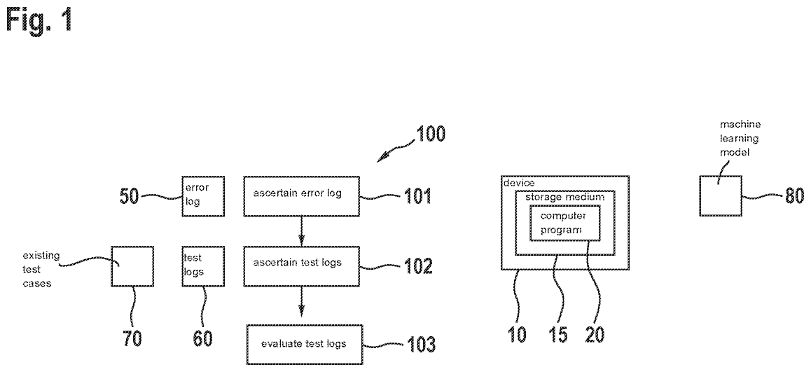

FIG. 1 schematically shows a method 100, a device 10, a storage medium 15, and a computer program 20 according to exemplary embodiments of the present invention. FIG. 1 furthermore illustrates the method steps for the automated analysis of software tests of a software. According to a first method step 101, an error log 50 about an incorrect execution of the software can be ascertained. In this respect, the error log 50 can specify an execution context of the incorrect execution. Thereafter, ascertaining test logs 60 can be provided according to a second method step 102. The test logs 60 can result from a performance of the software tests of the software that preceded the incorrect execution of the software. The software tests can comprise a plurality of existing test cases 70, which test various functions of the software. In this respect, the test logs 60 can specify a respective execution context of the existing test cases 70. The execution context can in particular be understood to mean that the context is specified with regard to the inputs and/or outputs of the software and, if necessary, further execution conditions in the execution of the software according to the test case or in the incorrect execution. According to a third method step 103, an evaluation of the test logs 60 on the basis of the error log 50 can subsequently be provided, wherein the evaluation 103 takes place on the basis of a similarity of the execution context of the incorrect execution to the respective execution context of the existing test cases 70. The evaluation 103 can take place at least partially on the basis of machine learning. This can also make it possible to generate, on the basis of the evaluation 103, a test case 70 that is suitable for reproducing the incorrect execution, wherein the generation of the test case 70 preferably takes place by a machine learning model 80 trained for this purpose.

Test cases are in particular one of the essential elements of a software test. A test case can represent the conditions under which the system to be tested is executed in order to find an error (bug). If a test case detects an error, the test is regarded as successful. The occurrence of errors or bugs means that the tests carried out are not sufficient and have some leakages. It therefore must be ensured that these errors or bugs do not occur again and that the software tests are improved by eliminating discovered leakages. A goal of exemplary embodiments of this invention can be for a machine learning (ML) method to be implemented in a test automation suite in order to check, for any serious defect or error, what can be improved in the software tests.

It can be provided that, for each new serious defect or error, it is first ensured that logs with information about the defect or error and/or about an execution of the software when the defect or error occurred are provided. Subsequently, it is possible to compare the provided logs to logs that have already been recorded by previous test campaigns and to analyze them. Machine learning algorithms can be used for this purpose. The analysis may show that an already defined test case can be improved. It can also be ascertained in which way the test case can be improved, for example with regard to its configuration and/or parameter settings, and/or the like. It is also possible that a proposal for a new test case is ascertained on the basis of the analysis, in particular on the basis of a series of already defined basic test steps. In addition, a notification can be output to the software tester that a proposal for a new test improvement or for the creation of a new test case is not possible and manual interaction is required in order to define the next steps for test improvement.

Furthermore, according to the aforementioned steps, test scripts can be generated automatically. The strategy used to create new tests or improve existing tests is, for example, based on the data mining AI algorithms of the logs provided with the serious error or defect. The values used to create new tests or improve the defined test paths can, for example, be ascertained directly from the logs by means of AI-ML algorithms. This approach has the advantage that it can be ensured that any reported error does not occur again in any application scenario, which leads to greater effectiveness and efficiency of the overall testing activities.

In order to train a machine learning model 80 for the evaluation and/or generation of the test case, training data can first be provided. In them, a plurality of test logs, as input data, and associated annotation data can be provided. In the annotation data, the logs can be correctly assigned to the preceding test cases for cases ascertained and/or constructed by way of example. The machine learning model 80 can, for example, comprise at least one artificial neural network, e.g., a convolutional neural network (CNN). A further possibility is the use of a recurrent neural network (RNN), which is particularly suitable for the processing of sequences, such as text or time series. The training can, for example, be carried out by means of back-propagation and/or supervised learning in order to adapt the weightings in the artificial neural network in this way. For example, the model 80 is trained on the training data in that the predictions are made on the basis of the input data and the weightings are then adapted by means of back propagation in order to achieve a better match with the annotation data. A check of the match can, for example, be carried out by means of a loss function. Used as a loss function is, for example, a mean squared error (MSE), preferably a categorical cross-entropy. A ReLU activation function for the hidden layers and the softmax activation function for the output layer can furthermore be used.

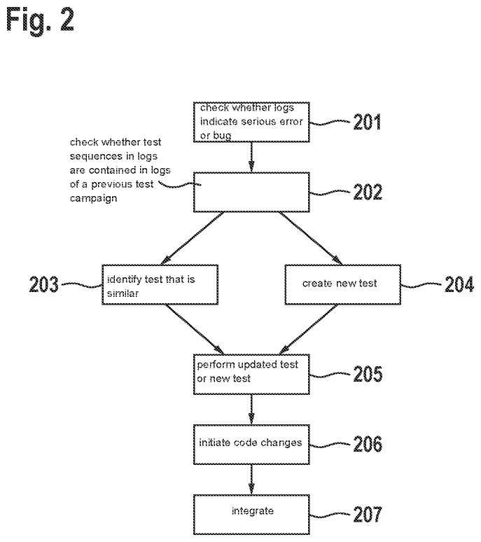

FIG. 2 illustrates exemplary embodiments of the present invention that use an adaptive approach. According to a step 201, it is first checked whether the logs indicate a serious error or bug and are thus to be regarded as error logs. According to step 202, machine learning algorithms can subsequently be used to check whether the test sequences in the provided logs are contained in the logs of a previous test campaign. According to step 203, if this is the case, the test that is similar to the test carried out in the provided logs can be identified. According to step 204, if this is not the case, a new test can be created on the basis of the specified test steps. According to step 205, it can be provided to perform the updated test or the newly created test in order to ensure that the error or defect is reproduced. According to step 206, code changes that are required to correct the error or defect can be initiated. According to step 207, the automatically adapted test or the newly created test can be integrated into the test artifacts or the test suite.

The above description of the embodiments describes the present invention solely in the context of examples. Of course, individual features of the embodiments can be freely combined with one another, if technically feasible, without leaving the scope of the present invention.

What is claimed is:

1. A method for automated analysis of software tests of software, comprising the following steps:
ascertaining an error log about an incorrect execution of the software, wherein the error log specifies an execution context of the incorrect execution;
ascertaining test logs that result from a performance of the software tests of the software that preceded the incorrect execution of the software, wherein the software tests include a plurality of existing test cases, through which various functions of the software are tested, wherein the test logs specify a respective execution context of the existing test cases;
carrying out an evaluation of the test logs based on the error log, wherein the evaluation takes place based on a similarity of an execution context of the incorrect execution to the respective execution context of the existing test cases, wherein the evaluation takes place at least partially based on machine learning.

2. The method according to claim 1, wherein, based on the evaluation, a test case that is suitable for reproducing the incorrect execution is generated, wherein the generation of the test case takes place by a machine learning model trained for this purpose.

3. The method according to claim 2, wherein the generated test case is based on at least one of the existing test cases, wherein the following steps are carried out for the generation:
identifying at least one of the existing test cases whose execution context has a greatest similarity to the execution context of the incorrect execution; and
adapting the identified at least one test case so that it is suitable for reproducing the incorrect execution;
wherein the adaptation takes place by changing a parameterization of the identified at least one test case.

4. The method according to claim 2, further comprising the following steps:
performing the generated test case; and
checking that the incorrect execution of the software is reproduced by execution of the generated test case;
adapting the software such that an error underlying the incorrect execution of the software is corrected in a program code of the software, and/or integrating the generated test case into a testing process.

5. The method according to claim 1, wherein a generative machine learning model is provided in order to carry out the evaluation, and to generate, based on the ascertained error log and test logs, a test case that is suitable for reproducing the incorrect execution, wherein the machine learning model has at least one of the following network architectures: a variational autoencoder, a generative adversarial network, an autoregressive model.

6. The method according to claim 1, wherein the generative machine learning model is a neural network.

7. The method according to claim 5, wherein the machine learning model is trained by the following steps:
ascertaining training data, wherein the training data include example error logs about various incorrect executions of the software and example test logs about software tests of the software, wherein test cases of the software tests lack suitability for reproducing the incorrect executions, and wherein the training data include annotation data specifying test cases that are suitable for reproducing the incorrect executions;
initiating weightings of the machine learning model;
carrying out a training process to optimize the weightings of the machine learning model based on the training data, wherein the training process uses a loss function that minimizes a difference between data generated by the machine learning model and the annotation data.

8. The method according to claim 5, wherein the evaluation is carried out repeatedly, so that continuous learning of the machine learning model is provided based on thereby ascertained error and test logs: (i) through re-training, in which the ascertained error and test logs are included in the training data, and/or (ii) through incremental learning.

9. A data processing device configured for automated analysis of software tests of software, the data processing device configured to:
ascertain an error log about an incorrect execution of the software, wherein the error log specifies an execution context of the incorrect execution;
ascertain test logs that result from a performance of the software tests of the software that preceded the incorrect execution of the software, wherein the software tests include a plurality of existing test cases, through which various functions of the software are tested, wherein the test logs specify a respective execution context of the existing test cases;
carry out an evaluation of the test logs based on the error log, wherein the evaluation takes place based on a similarity of an execution context of the incorrect execution to the respective execution context of the existing test cases, wherein the evaluation takes place at least partially based on machine learning.

10. A non-transitory computer-readable storage medium on which are stored instructions for automated analysis of software tests of software, the instructions, when executed by a computer, cause the computer to perform the following steps:
ascertaining an error log about an incorrect execution of the software, wherein the error log specifies an execution context of the incorrect execution;
ascertaining test logs that result from a performance of the software tests of the software that preceded the incorrect execution of the software, wherein the software tests include a plurality of existing test cases, through which various functions of the software are tested, wherein the test logs specify a respective execution context of the existing test cases;
carrying out an evaluation of the test logs based on the error log, wherein the evaluation takes place based on a similarity of an execution context of the incorrect execution to the respective execution context of the existing test cases, wherein the evaluation takes place at least partially based on machine learning.
